(19) United States
(12) Patent Application Publication
(10) Pub. No.: US 2014/0133302 A1
(43) Pub. Date: May 15, 2014

(54) TUNING ROUTING METRICS TO REDUCE MAXIMUM LINK UTILIZATION AND END-TO-END DELAY VIOLATIONS

(71) Applicants: SHAOJIAN FU, Greenville, NC (US); Bobby Ninan, Morrisville, NC (US); Gordon Bolt, Apex, NC (US); Vinod Jeyachandran, Potomac, MD (US)

(72) Inventors: SHAOJIAN FU, Greenville, NC (US); Bobby Ninan, Morrisville, NC (US); Gordon Bolt, Apex, NC (US); Vinod Jeyachandran, Potomac, MD (US)

(21) Appl. No.: 13/677,283

(22) Filed: Nov. 14, 2012

(51) Int. Cl. H04L 12/56

(52) U.S. Cl. CPC H04L 47/18
USPC 370/231

(57) ABSTRACT

A metric tuning technique optimizes the link utilization of a set of links in a network and end-to-end delay or latency constraints. In the embodiments, a delay constraint between node pairs in the network is determined and used in addition to the link utilization to optimize the network. An interactive user interface is provided to allow a user to specify limits and the delay constraints, and to select the sets of links to be addressed. The delay constraints may be specified on an end-to-end or per-link basis. In addition, the latency requirements may be specified for various types of traffic, such as voice, streaming, etc. In one embodiment, the link utilization is minimized within a node pair latency constraint. Link utilization constraints may be preferred before satisfying delay or latency constraints.

### CROSS-REFERENCE TO RELATED APPLICATIONS

This application claims priority to U.S. Provisional Patent Application No. 61/559,923, entitled “TUNING ROUTING METRICS TO REDUCE MAXIMUM LINK UTILIZATION AND END-TO-END DELAY VIOLATIONS,” filed Nov. 15, 2011 and is related to U.S. Pat. No. 8,228,804, entitled “TUNING ROUTING METRICS TO REDUCE MAXIMUM LINK UTILIZATION AND/OR OR PROVIDE FAILURE RESILIENCY,” which are both incorporated by reference herein in their entirety.

### BACKGROUND

The embodiments relate to network engineering and analysis, and in particular, to a method and system for managing traffic flow in a network for efficient link utilization and avoiding end-to-end delay violations.

In a typical network, data is routed over a variety of available paths through nodes in the network. Routing algorithms are generally structured to select a route for traffic between the nodes of a network based on the relative cost associated with each potentially available route. For example, an Interior Gateway Protocol (IGP) is commonly used on Internet Protocol (IP) networks to determine the optimal route from a source node to a destination node based on a total cost of each available route, using one or more metrics for determining such costs. Example IGPs include Routing Information Protocol (RIP), Open Shortest Path First (OSPF), and Intermediate System to Intermediate System (IS-IS) protocols. Typically, if the link is a high capacity link, the relative impact on the link's utilization of sending a packet over the link is generally low, compared to the impact of sending that same packet over a link with very limited capacity. Conventional routing algorithms thus assign low costs to high capacity links, and high costs to low capacity links. This causes more traffic to be routed to the high capacity links, thereby avoiding congestion on the low capacity links. Therefore, routing algorithms conventionally attempt to optimize routes based on link utilization. Likewise, conventional network analysis tools are typically designed to optimize link utilization.

However, the known routing algorithms and network tools generally do not account for delay constraints between node pairs or for a path through the network. This results in routes that are optimal for link utilization, but actually may result in longer delays or violations of desired delay constraints. Delay constraint can be a crucial part of a Service Level Agreement (SLA), which is the contracted level of performance delivered by Internet Service Providers (ISP) to their customers. Unfortunately, the known routing protocols and tools do not provide algorithms that optimize link utilization while also attempting to satisfy delay constraints, especially end-to-end delay.

### BRIEF DESCRIPTION OF THE DRAWINGS

The invention is explained in further detail, and by way of example, with reference to the accompanying drawings wherein:

FIG. 1 illustrates an exemplary traffic engineering system in accordance with the present invention;

FIGS. 1A-1D illustrate an example network, routing metrics, routes, and traffic load as a function of the metric for an example link;

FIG. 2 illustrates an exemplary process for determining whether a delay constraint is feasible;

FIGS. 3A-3D illustrate an exemplary interface-based algorithm in accordance with an embodiment of the present invention; and

FIGS. 4A-4C illustrates an exemplary flow-based algorithm in accordance with an embodiment of the present invention.

Throughout the drawings, the same reference numerals indicate similar or corresponding features or functions. The drawings are included for illustrative purposes and are not intended to limit the scope of the claimed embodiments.

### DETAILED DESCRIPTION

Overview—Optimization Based on Link Utilization AND Delay

The embodiments provide traffic-engineering methods and systems that attempt to optimize network performance for both link utilization and any desired delay constraints. Link utilization refers to any measure of bandwidth or data rate needed by nodes in the network to transport data. In some embodiments, the methods and systems will attempt to satisfy the link utilization constraint before satisfying the delay constraints. In other embodiments, the methods and systems will attempt to satisfy the delay constraints first and then determine the effect on link utilization.

Delay constraints relate to the amount of time allowed by the network to transport the data. The delay constraints can be specified explicitly, for example, via a user input, or computed automatically, for example, from Service Level Agreements that are defined contractually by the network provider. The delay constraints can be specific to any portion of the network, such as a particular node pair, or to an overall end-to-end delay.

In some embodiments, the methods and systems employ a node pair latency matrix in order to determine the latency and delay of the various node pairs in the network. The latency matrix tracks the time it takes for data to travel from the source to the destination along a computed route in the network independent of congestion. The latency matrix may also be adjusted to track the time it takes for data travel based on congestion or other factors, such as a network failure, etc. If there are multiple routes, the latency matrix may specify different values, such as the maximum value, the minimum value, the median value, the mean value, etc. between node pairs.

Compliance with the delay constraints can be achieved by a variety of algorithms in the embodiments. For purposes of illustration, two types of algorithms of the present invention are presented as examples: one is referred to as an interface-based algorithm and the other is referred to as a flow-based algorithm. The interface-based algorithm changes the metric of one interface at a time. The flow-based algorithm changes metric(s) of one or more interfaces affecting one flow at a time. Other embodiments for accounting for delay constraints may be recognized by those skilled in the art.

Certain embodiments of the inventions will now be described. These embodiments are presented by way of example only, and are not intended to limit the scope of the inventions. Indeed, the novel methods and systems described herein may be embodied in a variety of other forms. Furthermore, various omissions, substitutions and changes in the form of the methods and systems described herein may be made without departing from the spirit of the inventions. For example, for purposes of simplicity and clarity, detailed descriptions of well-known components, such as circuits, are omitted so as not to obscure the description of the present invention with unnecessary detail. To illustrate some of the embodiments, reference will now be made to the figures.

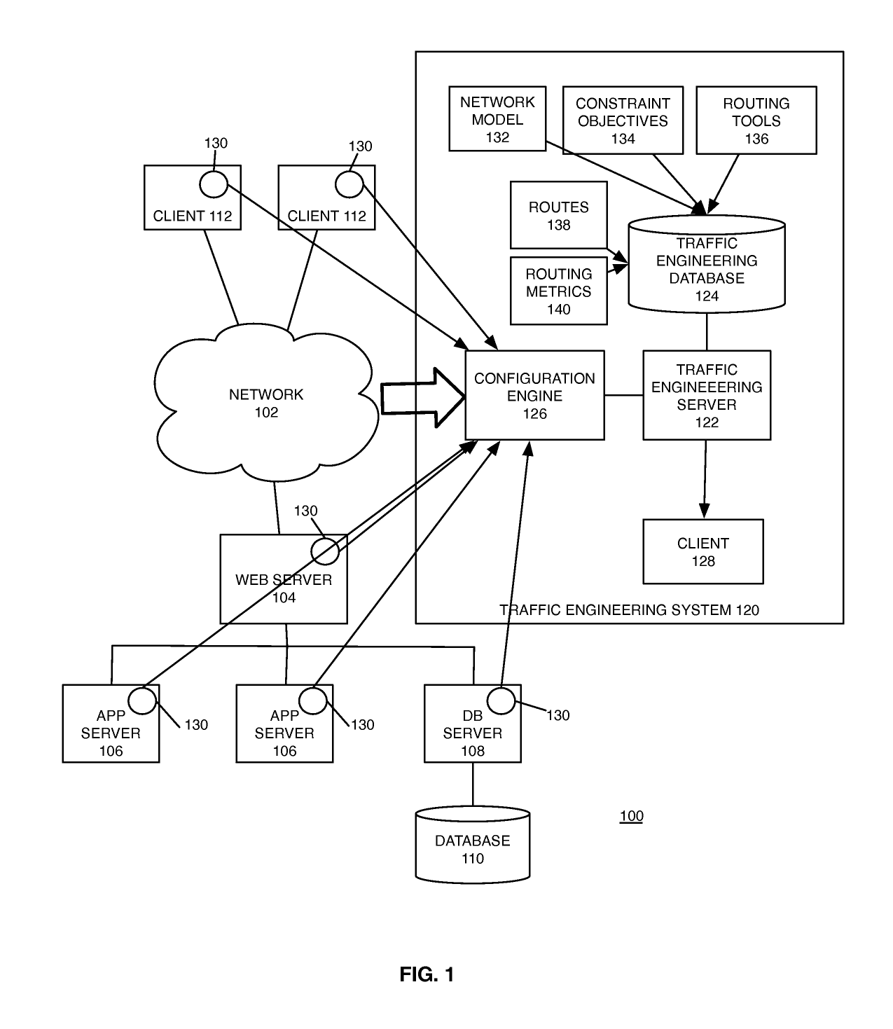

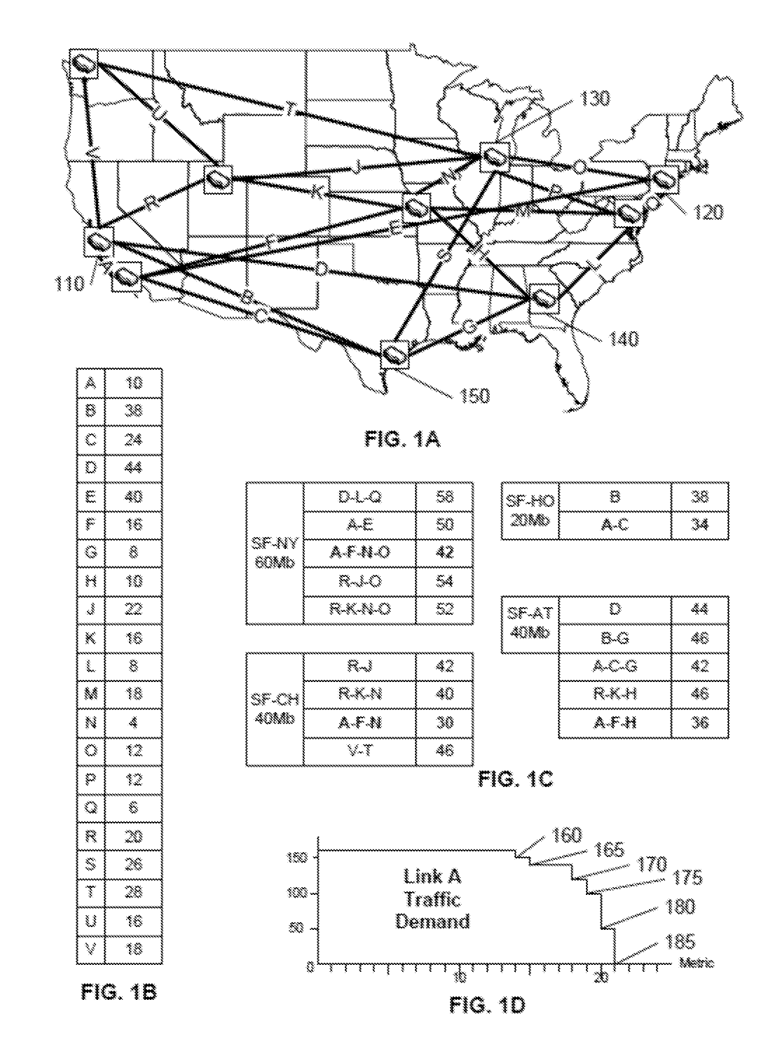

FIG. 1—Exemplary Network and Traffic Engineering System

FIG. 1 illustrates an exemplary traffic engineering system in accordance with an embodiment of the present invention. As shown, the system 100 may comprise a network 102 and traffic engineering system 120. These components are briefly described below. Those skilled in the art will also recognize that any type of network may the subject of the embodiments.

FIG. 1 also shows an exemplary traffic engineering system 120. The traffic engineering system 120 may comprise a traffic engineering server 122, a traffic engineering database 124, and a configuration engine 126. The traffic engineering server 122 may be accessed via its own type of client, such as a client 128. These components are also further described below.

Components of an Exemplary Network

As noted, the traffic engineering system 120 may attempt to optimize network performance for any portion of network 102 as well as end-to-end delay constraints. Accordingly, the traffic engineering system 120 may not only account for delay within network 102, but also the various components coupled to the network 102, such as the web server 104, application servers 106, clients 112, etc. For purposes of illustration, FIG. 1 illustrates the analysis of a typical network system for delivery of web services and applications over network 102. Accordingly, from end-to-end, network 102 is shown connecting a web server 104, application servers 106, a database server 108, a database 110, a set of clients 112, etc. These components will now be described further below.

Network 102 represents the communications infrastructure that carries data between a source and destination. Network 102 may comprise various nodes as its network elements, such as routers, firewalls, hubs, switches, etc. In one embodiment, the network 102 may support various communications protocols, such as TCP/IP. Network 102 may refer to any scale of network, such as a local area network, a metropolitan area network, a wide area network, the Internet, etc.

Web server 104 provides content to the clients 112 over a network, such as network 102. Web server 104 may be implemented using known hardware and software to deliver application content. For example, web server 104 may deliver content via HTML pages and employ various IP protocols, such as HTTP.

Application servers 106 provide a hardware and software environment on which the applications may execute over network 102. In one embodiment, applications servers 106 may be implemented based as Java Application Servers, Windows Server implement a .NET framework, LINUX, UNIX, WebSphere, etc. running on known hardware platforms. Application servers 106 may be implemented on the same hardware platform as the web server 104, or as shown in FIG. 1, they may be implemented on their own hardware.

In one embodiment, applications servers 106 may provide various applications, such as mail, word processors, spreadsheets, point-of-sale, multimedia, etc. Application servers 106 may perform various transaction related to requests by the clients 112. In addition, application servers 106 may interface with the database server 108 and database 110 on behalf of clients 112, implement business logic for the applications, and other functions known to those skilled in the art.

Database server 108 provides database services to database 110 for transactions and queries requested by clients 112. Database server 108 may be implemented using known hardware and software. For example, database server 108 may be implemented based on Oracle, DB2, Ingres, SQL Server, MySQL, etc. software running on a server.

Database 110 represents the storage infrastructure for data and information requested by clients 112. Database 110 may be implemented using known hardware and software. For example, database 110 may be implemented as relational database based on known database management systems, such as SQL, MySQL, etc. Database 110 may also comprise other types of databases, such as, object oriented databases, XML databases, and so forth.

Clients 112 refer to any device requesting and accessing services of applications provided by modeled network 102. Clients 112 may be implemented using known hardware and software. For example, clients 112 may be implemented on a personal computer, a laptop computer, a tablet computer, a smart phone, and the like. Such devices are well-known to those skilled in the art and may be employed in any of the embodiments.

The clients 112 may access various applications based on client software running or installed on the clients 112. The clients 112 may execute a thick client, a thin client, or hybrid client. For example, the clients 112 may access applications via a thin client, such as a browser application like Internet Explore, Firefox, etc. Programming for these thin clients may include, for example, JavaScript/AJX, JSP, ASP, PHP, Flash, Silverlight, and others. Such browsers and programming code are known to those skilled in the art.

Alternatively, the clients 112 may execute a thick client, such as a stand-alone application, installed on the clients 112. Programming for thick clients may be based on the .NET framework, Java, Visual Studio, etc.

An Exemplary Traffic Engineering System

The traffic engineering system 120 may comprise various hardware and software used for monitoring and managing the modeled network 102. As shown, traffic engineering system 120 may comprise a traffic engineering server 122, a traffic engineering database 124, a configuration engine 126, a user interface client 128, and agents 130. These components will now be further described.

The Traffic Engineering Server and Database

Traffic engineering server 122 serves as the host of traffic engineering system 120 and provides the processing for the algorithms of the embodiments. Traffic engineering server 122 may be implemented using known hardware and software. Traffic engineering server 122 may be implemented as software running on a general-purpose server. Alternatively, traffic engineering server 122 may be implemented as an appliance or virtual machine running on a server.

Traffic engineering database 124 provides a storage infrastructure for storing the traffic engineering information processed by the traffic engineering server 122. For example, the traffic engineering database 124 may comprise a model 132 of the network 102, information related to the constraint objectives 134 of the network 102, one or more routing tools 136, routes 138 calculated for the network 102, and the routing metrics 140 collected by configuration engine 126. Traffic engineering database 124 may be implemented using known hardware and software.

The traffic engineering server 122 accesses the network model 132 in traffic engineering database 124 that describes an actual network (e.g., network 102), or a proposed network, or a combination of actual and proposed components forming a network. For ease of reference, the model 132 of network 102 is presented hereinafter as being an actual network.

In some embodiments, the user is provided the option of defining constraints that are to be enforced, if possible, by the traffic engineering server 122. The user is also provided the option of defining or selecting objectives in the form of tasks to be accomplished by the traffic engineering server 122. For example, the user may use client 128 to provide an objective as being the elimination of any current constraint violations, or a reduction in peak link utilization, or an identification of preferred metric changes from a least-cost maximum-benefit viewpoint, and so on.

One or more routing tools 136 may be hosted in the traffic engineering database 124 and are provided to emulate or simulate the routing algorithms that are used at the components of network 102. The routing algorithms used by routing tools 136 determine the routing for traffic between source and destination nodes on the network, based on the topology of the network 102 and the routing metrics 140. The topology of the network may be provided by the network model 132, or derived from the network 102 by the configuration engine 126, or a combination of both.

The traffic between a source and destination is generally defined as a demand for a given amount of traffic per unit time, and may be included in the network model 132, or provided from an alternative source, typically via the user interface provided by client 128. In one embodiment, the user is provided the option of adding, deleting, or modifying the defined traffic between nodes at the client 128.

In accordance with the principles of this invention, the traffic engineering server 122 is configured to evaluate the performance of the modeled network based on the defined routing of traffic among the nodes of the network, and to identify preferred changes to the metrics to satisfy the defined objectives, subject to the defined constraints, for presentation to the user at client 128. The techniques used by the traffic engineering server 122 for identifying the preferred changes to the metrics 140, and for performing other tasks, are described further below.

If the user decides to implement select changes to the metrics 140, the traffic engineering server 122 is also configured to communicate revised metrics to the configuration engine 126. In turn, the configuration engine 126 may be configured to communicate these revised metrics to the appropriate nodes in the network 102, for example, as configuration commands to be implemented.

The Configuration Engine

Configuration engine 126 collects information from the components of network 102, web server 104, application server 106, database server 108, etc. In particular, the configuration engine 126, which may be a component of the traffic engineering server 122, queries the components of the network 102 to determine the network configuration, including the current routing metrics 140.

For example, configuration engine 126 may receive information via agents 130 from clients 112, web server 104, application servers 106, database server 108, and network 102. The information may comprise a variety of information, such as simple network management protocol (“SNMP”) information, trace files, system logs, etc. Configuration engine 126 may be implemented using known hardware and software. For example, configuration engine 126 may be implemented as software running on a general-purpose server. Alternatively, configuration engine 126 may be implemented as an appliance or virtual machine running on a server.

The Client of the Traffic Engineering System

Client 128 serves as an interface for accessing traffic engineering server 122. For example, the client 128 may be implemented as a personal computer running an application or web browser accessing the traffic engineering server 120.

Client 128 may be implemented using known hardware and software. For example, the client 128 may be also be implemented on a mobile device, such as a smartphone or tablet, a laptop, and the like.

Agents of the Traffic Engineering System

In some embodiments, the traffic engineering system is coupled to an actual network, such as network 102. Accordingly, as shown in FIG. 1, one or more agents 130 may be installed in various nodes of network 102 and serve as instrumentation for the traffic engineering system.

Agents 130 may be implemented as software running on the components or may be a hardware device coupled to the component. For example, for agents 130 on nodes in network 102, the agents 130 may be SNMP network monitoring agents.

In addition, the agents 130 may implement monitoring instrumentation for Java and .NET framework applications. In one embodiment, the agents 130 implement, among other things, tracing of method calls for various transactions. In particular, in one embodiment, agents 130 may interface known tracing configurations provided by Java and the .NET framework to enable tracing periodically, continuously, or in response to various events. Based on this information, the agents 130 may thus provide information related to end-to-end delay experienced by traffic running across network 102.

FIGS. 1A-1D—Examples of Routing Optimization

FIGS. 1A-1D are provided to help illustrate how the routing metrics affect link utilization and delay. FIG. 1A illustrates an example network with links A-V between nodes of the network. FIG. 1B illustrates an example set of metrics associated with each link A-V, and FIG. 1C illustrates an example set of routes and composite metrics associated with each. In this example, only four traffic flow demands are presented for illustration, from San Francisco 110 to each of: New York 120 (SF-NY, 60 Mb/s), Chicago 130 (SF-CH, 40 Mb/s), Atlanta 140 (SF-AT, 40 Mb/s), and Houston 150 (SF-HO, 20 Mb/s). The composite metric for the routes is determined in this example as the sum of the metrics of the links along the route; other techniques for determining a composite metric based on link metrics may also be used, such as a composite that is based on the metric of each link and the number of links (hops) along the route.

In FIG. 1C, five sample routes are illustrated for the traffic from SF 110 to NY 120. The first route, using links D (SF to AT), L (AT to DC), and Q (DC to NY), has a composite metric of 58 (44+8+6); the second route, A-E, has a composite metric of 50 (10+40), the third route, A-F-N-O, has a composite metric of 42 (10+16+4+12), and so on. Based on these composite metrics, the 60 Mb/s traffic from SF to NY is preferably routed along the route A-F-N-O, the route with the lowest composite metric. In like manner, the 40 Mb/s traffic from SF to CH is preferably routed along A-F-N; the 20 Mb/s traffic from SF to HO along route A-C; and the 40 Mb/s traffic from SF to AT along route A-F-H.

Of note, in this example, each of the preferred routes include the link A. Therefore all of the traffic from SF to NY, CH, HO, and AT will travel over link A. With the routing in this example, link A will have 160 Mb/s of load. Whether or not link A can efficiently handle this load is based on the capacity of link A. If link A's capacity is 320 Mb/s, for example, its utilization is 50%; if link A's capacity is under 160 Mb/s, link A is over-utilized, and the traffic demand will not be satisfied. Network managers strive to avoid over-utilized links, and try to minimize the link utilization on each of the links to assure efficient traffic flow across the network.

Typically, when a link is added to a network, the metric is assigned at the interface to the link, reflecting the relative cost/impact of using the link. For example, if the link is a high capacity link, the relative impact of sending a packet over the link is generally slight, compared to the impact of sending that same packet over a link with very limited capacity. By assigning low costs to high capacity links, and high costs to low capacity links, more traffic will generally be routed by such cost/metric based routing algorithms to the high capacity links, thereby avoiding congestion on the low capacity links. However, these techniques do not account for delay constraints that may be desired, such as for SLA obligations.

In FIG. 1D, the load across link A is illustrated as a function of link A's metric. For example, as noted above (in FIG. 1B), the metric of link A has a metric value of 10. Based on this metric, each of the four traffic demands (SF-NY, SF-CH, SF-AT, SF-HO) are preferably routed along link A, amounting to 160 Mb/s, as discussed above. If link A's metric is increased to 11, there will be no change, because the composite metric for each preferred route A-F-N-O (43), A-F-N (31), A-F-H (37), and A-C (35) based on this metric will still be the lowest among the alternative routes for each demand.

If link A's metric is 14, the composite metric for route A-C (14+24) will be equal to the composite metric for route B (38) for the demand SF-HO. In that case, the 20 Mb/s demand from SF to HO will be shared equally by route B and route A-C, reducing the load on link A to 150 Mb/s (160−(20/2)), as illustrated at 160 in FIG. 1D. If link A's metric is 15, the composite metric for route A-C (15) will be larger than the metric for route B (14), and thus route B will be the preferred route, removing all of the 20 Mb/s demand from SF to HO from link A, as illustrated at 165 of FIG. 1D.

If link A's metric is 18, the composite metric for route A-F-H (18+16+10) will equal the composite metric for route D (44) for the demand SF-AT, and half of the 40 Mb/s demand will be shared between route D and route A-F-H, removing another 20 Mb/s from the demand on link A, as illustrated, at 170. If link A's metric is 19, route D will be preferred for this demand, and the entire 40 Mb/s demand from SF to AT will be removed from link A, as illustrated at 175.

Similarly, if link A's metric is 20, the 50 Mb/s demand from SF to NY will be shared between route A-F-N-O and route R-K-N-O, and the 40 Mb/s demand from SF to CH will be shared between route A-F-N and R-K-N, reducing the load on link A by another 50 MB/s, as illustrated at 180; and completely removed from link A if link A's metric is 21 or more, as illustrated at 185.

Note that a similar off-loading of demand from link A can also be achieved by reducing the metric of other links. For example, if link A's metric is the original value of 10, reducing link B's metric to 34 will result in the sharing of the SF-HO demand between routes A-C and B, and reducing link B's metric will remove the entire SF-HO demand from link A. In this case, the reduction of load on link A is achieved by ‘attracting’ load to link B.

Accordingly, those skilled in the art will recognize that the change of one metric may affect the margin of improvement that subsequent changes of the remaining metrics will provide. That is, in the selection of metrics to change, the margins of improvement are based on the current level of performance, and the selection of the first metric change will provide a different current level of performance than the next change will provide. In some embodiments, multi-variate optimization techniques are thus used.

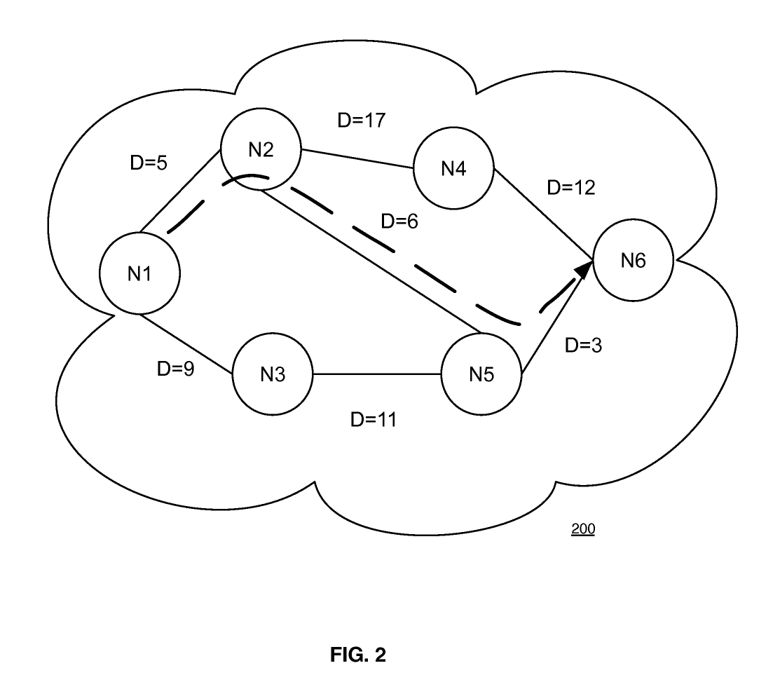

FIG. 2—Determining Feasibility of Delay Constraints

As noted above, in the embodiments, delay constraints may be specified in a variety of ways. However, there may be cases where the specified delay constraints are not feasible i.e. they can never be achieved using the existing network infrastructure. Accordingly, in the embodiments, the traffic engineering server 122 may compute a propagation delay lower bound to determine if the delay constraint is feasible based on the lowest possible value for latency between node pairs or portion of the network 102.

FIG. 2 is thus provided to show an example of computing a propagation delay lower bound. In the example shown, a model 200 of a network is illustrated for a flow from node N1 to node N6 that may be used in the embodiments. Of note, the model 200 shows a simplified network topology for illustrative purposes only. Based on the model 200, the traffic engineering server 122 may employ an algorithm that constructs a graph network's topology and sets the weight of the links in this graph as the propagation delay of the corresponding links to determine a lower bound of delay.

For example, the traffic engineering server 122 may use Dijkstra's shortest path algorithm to find the shortest path from source to destination. In the example illustrated, the shortest path is the highlighted route N1->N2->N5->N6. The propagation delay lower bound is the sum of weights along the shortest path (i.e., 5+6+3), which equals 14 in the example shown. This lower bound thus specifies the lowest value that can be used as a delay constraint for traffic between nodes N1 and N6.

If a delay constraint is not feasible, the traffic engineering server 122 may provide a warning or request a revised delay constraint, for example, via client 128. Non-feasible delay constraints may also be highlighted, such as with a different color, font, etc., by the traffic engineering server 122. In some embodiments, the traffic engineering server 122 may provide a suggested delay constraint that is feasible relative to the lower bounds.

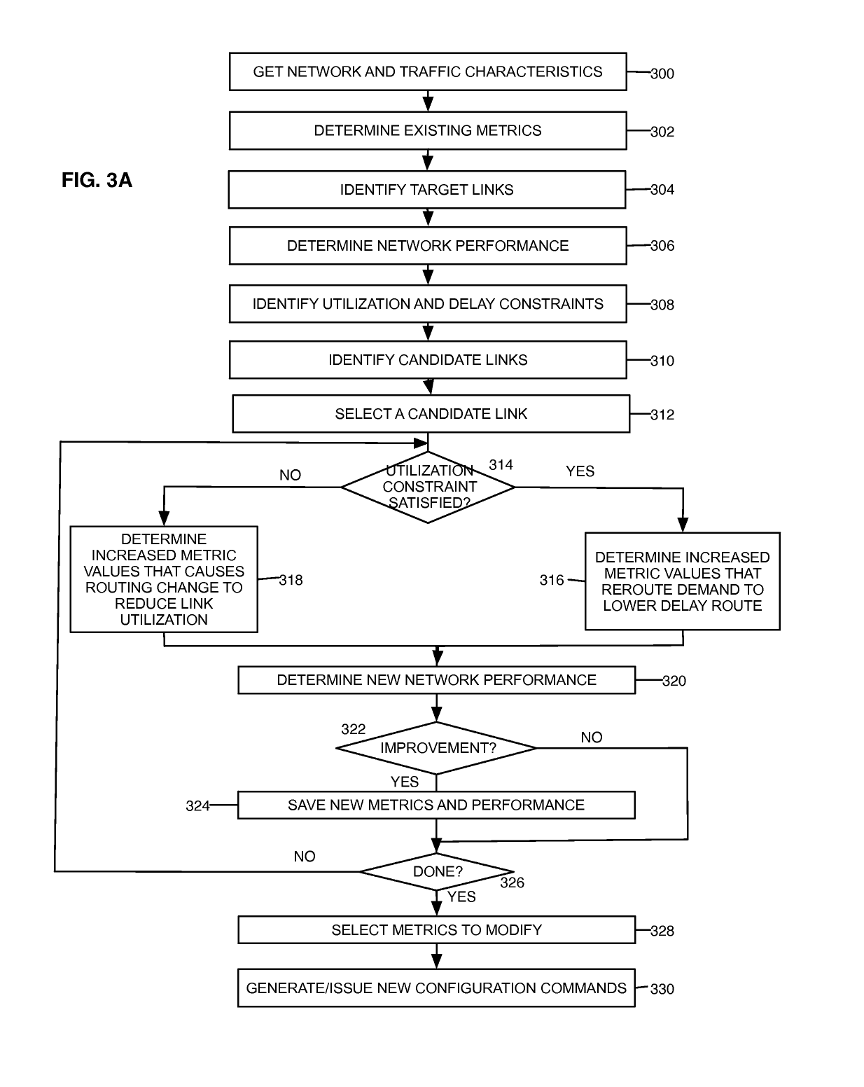

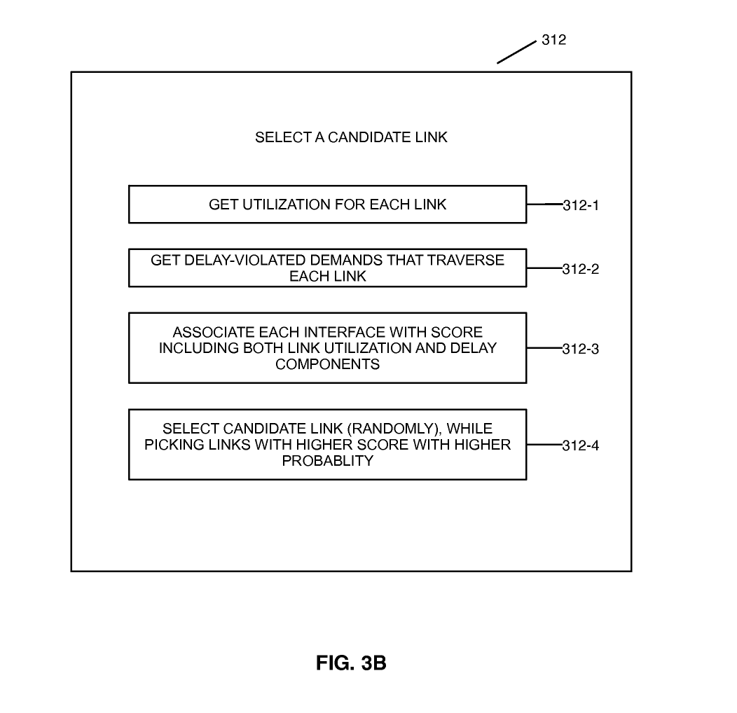

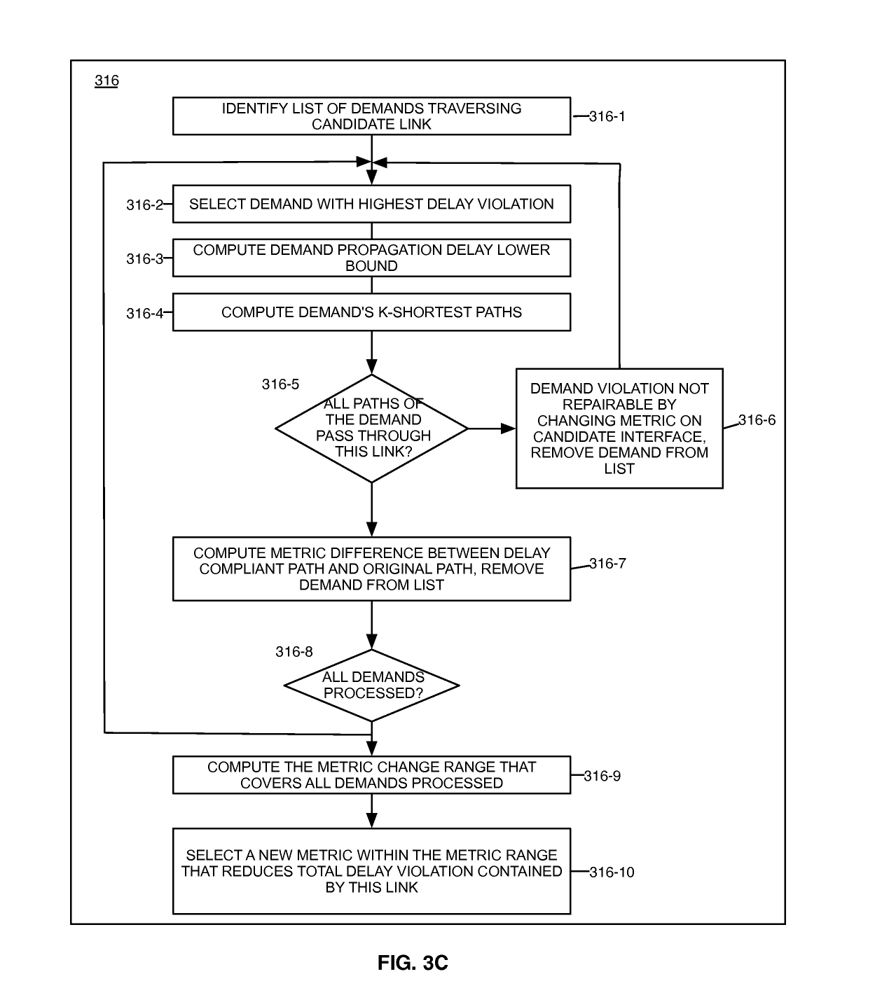

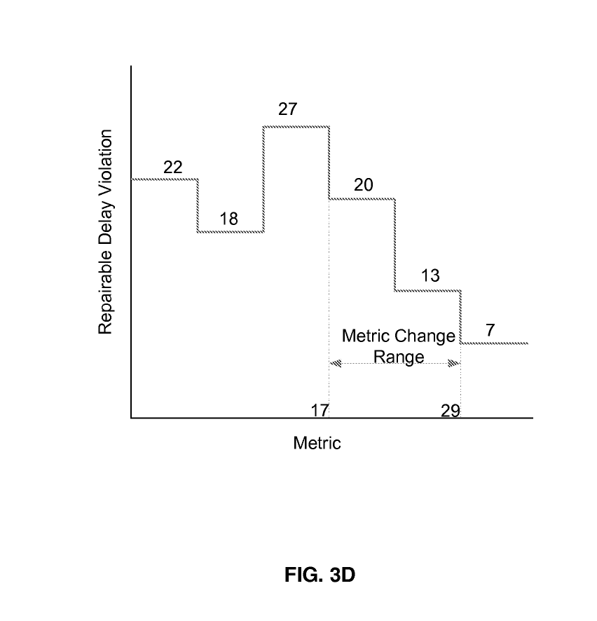

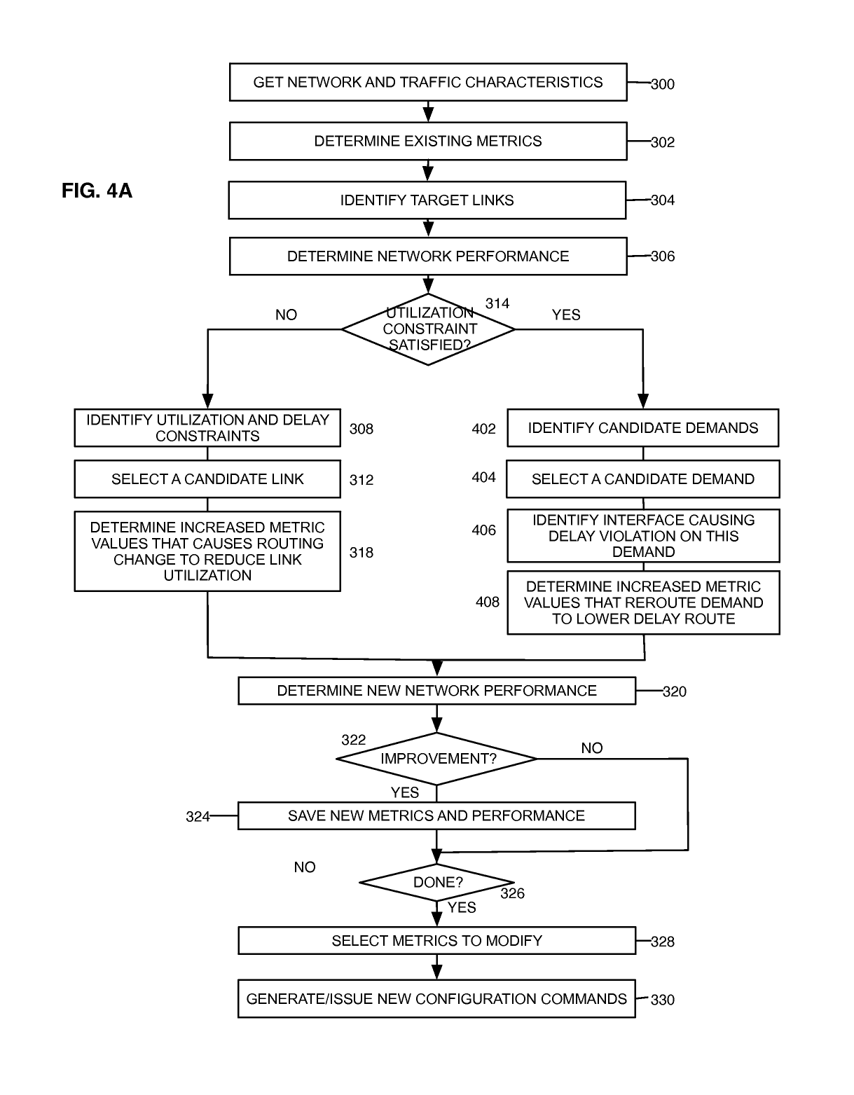

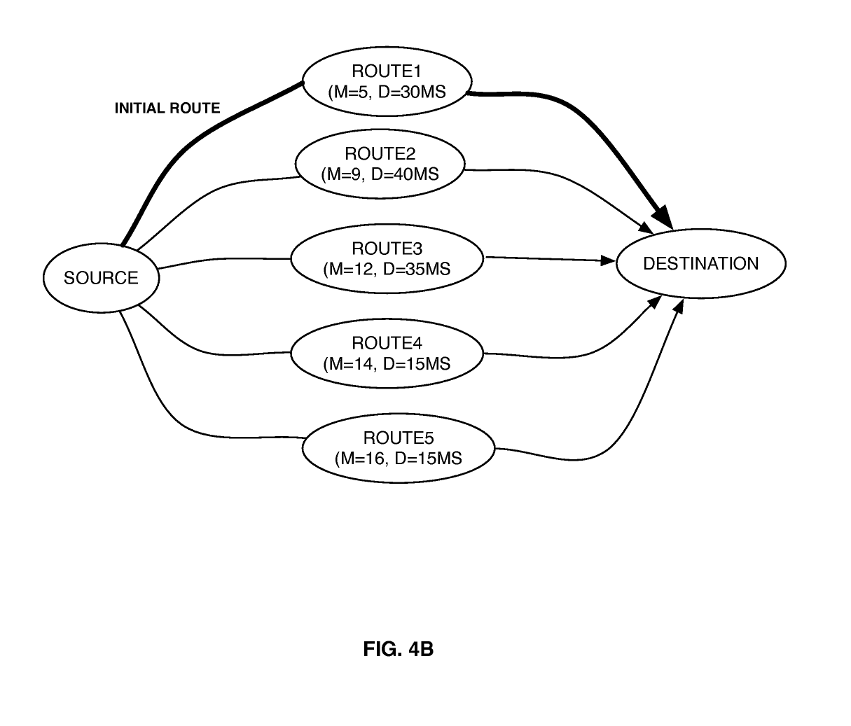

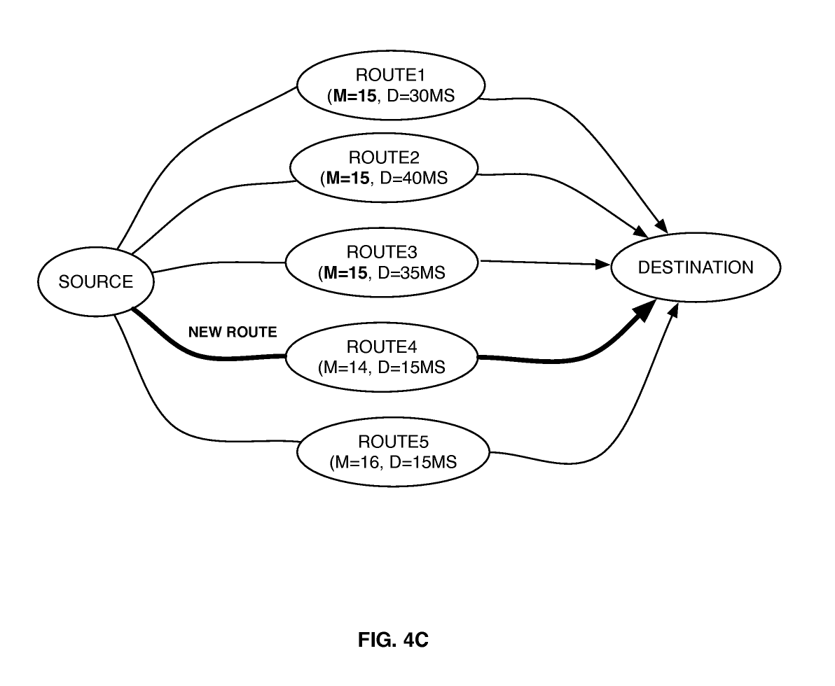

Once the delay constraints have been checked for feasibility, the traffic engineering server 122 may then determine how to optimize the configuration of the network 102 to comply with these desired delay constraints. As noted above, the traffic engineering server 122 may employ various algorithms alone or in combination. FIGS. 3A-3D illustrates an exemplary node interface algorithm and FIGS. 4A-4C illustrates an exemplary flow-based algorithm.

FIGS. 3A-3D—Exemplary Interface-Based Algorithm

FIGS. 3A-3D illustrate an exemplary algorithm that uses an interface-based approach. In particular, the algorithm changes the metrics of links in the network one interface at a time. The algorithm identifies candidate links on each interface that can be changed. After identifying the candidate links, the algorithm picks a candidate link by considering both link utilization and delay-violated flows traversing this link. Next the algorithm calculates the new metric value to be set on the selected candidate interface.

In some embodiments, if the link utilization on the selected candidate interface is above the link utilization constraint, the algorithm tries to find a metric value to reduce the max link utilization following the algorithm in co-pending U.S. Pat. No. 8,228,804, which is herein incorporated by reference in its entirety. On the other hand, if the link utilization constraint has already been satisfied, the algorithm calculates a metric value to reduce the delay violations without breaking the utilization constraint. The process will now be described in detail with reference to FIGS. 3A-3D.

Exemplary Overall Process

Referring now to FIG. 3A, in stage 300, the network and traffic characteristics are obtained. For example, the agents 130 may collect information from the nodes of network 102 and provide this information to the configuration engine 126. In turn, the configuration engine 126 may provide this information to traffic engineering server 122 for analysis and archive this information in traffic engineering database 124.

The characteristics include, for example, the network topology in model 132 and a traffic matrix. The network topology in model 132 includes an identification of each of the links of the network, and their characteristics, such as the routing protocol used at the interfaces to the links. The traffic characteristics identify the amount of traffic flowing between nodes of the network 102. Other parameters and characteristics may also be obtained, as required for subsequent processes.

In stage 302, the traffic engineering server 122 assess the information collected to determine the existing metrics 140 that are used for creating routes on this network 140. Generally, the particular routing protocol is predefined, and may include, for example, Open Shortest Path First (OSPF), and Intermediate System to Intermediate System (IS-IS) protocols. The traffic engineering server 122 may employ information from routing tools 136 for these routing protocols.

With routing tools 136, the traffic engineering server 122 may determine the particular routing protocol used at each interface to each link and to determine resultant routes 138 as the metrics are changed. For comparative consistency, the traffic engineering server 122 may determine the routes corresponding to the existing metrics. Optionally, some or all of the metrics 140 of the network 102 can be initialized to default or particularly defined values, to allow the traffic engineering server 122 to start from a preferred baseline configuration.

In stage 304, the traffic engineering server 122 identifies the links that are to be targeted for optimization. For ease of reference and understanding, two sets of links are defined herein, target links and candidate links. Target links are the links for which the performance of the network 102 is evaluated and potentially improved. Candidate links are the links that are available for change. Generally, these sets of links are the same, but in some cases, may be different. For example, a user may specify links via client 128 that may not be changed, or that may only be changed in a particular manner. Often, such links are on critical or sensitive routes, such as routes for particularly important customers, routes that have been optimized for a particular purpose, and so on. Although, the metrics 140 associated with the links along a sensitive route may be specified to remain the same, thereby maintaining the existing route, these links may generally be included in the determination of the measure of overall performance, because a metric change at another link might either reduce or increase the utilization of the targeted link. In like manner, the optimization may be targeted to cure known problems on particular links, and changes to any link that is not barred from change would be a candidate for change consideration.

Any of a variety of techniques may be used to identify the set of target links, ranging, for example, from having a user explicitly identify each link via client 128, to performing an exhaustive assessment of all links. Generally, the user may use client 128 to identify any links that are known to be problematic, or instructs the traffic engineering server 122 to assess the “N” links with the highest link utilization, or instructs the system to assess any link that violates one or more constraints, and so on. In addition to such ‘targeted’ assessments, the system may also be configured to select random target links for assessment, to determine if improvements can be achieved.

In stage 306, the traffic engineering server 122 determines a measure of network performance by network 102 with regard to the targeted links. Any of a variety of network performance measures may be used to assess the effectiveness of the current routing over these links. In an example embodiment of this invention, link utilization is used as a measure of effectiveness, and the peak link utilization among the targeted links is used as a network performance measure. This information may be determined, for example, based on information collected by agents 130 and archived in traffic engineering database 124.

In like manner, a threshold value of link utilization can be specified, and the number of targeted links that exceed this threshold value can be used as the network performance measure. Other statistics based on link utilization, such as average, mean, variance, and so on, may also be used. Other parameters may also be used, such as throughput, delay, number of links/hops per path, and so on. Preferably, a network performance measure that is easy to determine is preferred, to facilitate rapid iterative performance determinations.

The measure of network performance is typically a combination of individual performance measures. For example, the measure may be dependent upon the peak link utilization as well as other measures, such as the average link utilization, the number of link utilizations that exceed a threshold limit, and so on.

In stage 308, the traffic engineering server 122 identifies which of the constraints 134 are to be applied to the current optimization, such as utilization and delay constraints. In some embodiments, the constraints 134 include both operational and parametric constraints. Operational constraints may include, for example, an identification of links that should not be modified, high priority links, and so on, while parametric constraints may include, for example, limits imposed on system or network parameters, such as link utilization, the possible values for the metric, the number of links exceeding a given threshold, the number of demands using each link, and so on.

In stage 310, the traffic engineering server 122 identifies a set of change candidates, e.g., candidate links. In one embodiment, any link whose metric is not explicitly prohibited from change can be identified as a candidate link. In many cases, the set of candidate links is determined based on the constraints 134. For example, the set of change candidates might include only those links whose utilization is above 80%.

In stage 312, the traffic engineering server 122 selects a candidate link for change of one or more of its metrics. In one embodiment, the traffic engineering server 122 selects candidate links in decreasing order based on utilization. However, the traffic engineering server 122 may use any order and other selection criteria. For example, a user at client 128 may provide a desired criteria or preferred order of selecting candidate links. FIG. 3B provides a more detailed example below of how traffic engineering server 122 selects candidate links.

In stage 314, in some embodiments, the traffic engineering server 122 first determines whether the metric change causes a link utilization violation before optimizing for delay constraints. For example, the traffic engineering 122 may check the effect of the change in comparison to a link utilization constraint indicated by constraints 134 in database 124.

If the change does not cause a link utilization violation (i.e., the link utilization constraint is satisfied), processing flows to stage 316. In stage 316, the traffic engineering server 122 determines the changes to the metric on the interface that causes traffic to be routed to another lower delay route. FIG. 3D provides a more detailed illustration below of this processing stage.

However, if the change causes a link utilization violation, processing flows to stage 318. In stage 318, the traffic engineering server 122 is configured to first satisfy link utilization, and thus, determines another change to the metric on the interface that causes routing to stay within the link utilization constraint. For example, the traffic engineering server 122 may use routing tools 136 and routing metrics 140 to calculate a routing protocol response to the metric change on candidate link.

In stage 320, the traffic engineering server 122 determines the effect of the metric change on the candidate link on the performance of network 102. For example, the traffic engineering server 122 may calculate the effect using network model 132.

In stage 322, the traffic engineering server 122 determines whether the metric change resulted in an improvement. For example, the traffic engineering server 122 may use network model 132 to determine the effect of the metric change. FIGS. 3C-3D are provided below to describe this stage in more detail.

If the change resulted in an improvement, then the traffic engineering server 122 saves the new metric in traffic engineering database 124.

If the change did not result in an improvement, then processing flows to stage 326. In stage 326, the traffic engineering server 122 determines if it is done adjusting the metrics in the network. For example, the traffic engineering server 122 may be configured to seek changes above a threshold level, such as a 10% improvement, a 20% improvement, etc.

If the traffic engineering server 122 is not done analyzing metric changes, then processing loops back to stage 312 and processing repeats until a satisfactory performance improvement is achieved. In some embodiments, the analysis may be performed for any interface metric in the network, not just the currently selected link. Although the loop is illustrated as a sequential as a one link after another, process, the traffic engineering server 122 may be configured to identify improvements to the system performance based on multiple modifications to a plurality of links.

If the traffic engineering server 122 is done changing the metrics of the network, processing flows to stage 328. In stage 328, the traffic engineering server 122 selects the metrics to modify in network 102 corresponding to optimizations performed above.

In stage 328, the traffic engineering server 122 generates the new configuration commands to be applied in network 102. For example, the traffic engineering server 122 may refer to routes 138 and routing tools 136 to determine how to format the commands for achieving the desired metric change. The configuration engine 126 may then work cooperatively with traffic engineering server 122 to send these commands to the network 102.

FIG. 3B—Example of Selecting a Candidate Link

Referring now to FIG. 3B, a more detailed illustrating of how the traffic engineering server 122 may select a candidate link will now be described. As noted, in this stage, the traffic engineering server 122 selects a candidate link from the set of change candidates.

In stage 312-1, the traffic engineering server 122 obtains the link utilization of the candidate link. The traffic engineering server 122 may obtain this information from traffic engineering database 124.

In stage 312-2, the traffic engineering server 122 determines those delay constraints that are currently violated. The traffic engineering server 122 may identify those constraints, for example, for constraints 134.

In stage 312-3, the traffic engineering server 122 associates each interface of a node with a score to include both link utilization and delay components. The traffic engineering server 122 may use a composite scoring policy to consider both link utilization and flow delay constraint violation.

In stage 312-4, the traffic engineering server 122 selects the candidate link. In some embodiments, the traffic engineering server 122 selects the candidate link randomly, while picking links with a higher probability. In some embodiments, a link with a link utilization violation may be selected with highest priority. If no such link exists, a link that contains delay-violated flows is randomly selected.

FIG. 3C—Example of Determining Metric Performance Effect

FIG. 3C provides a more detailed description of stage 316 and how the traffic engineering server 122 determines whether an improvement in the measure of system performance can be achieved by modifying the metric that characterizes this link to the routing protocol. As noted, in this stage, the candidate link is assessed to determine a change to the value of its metric that causes a desired change to the original routing.

Not all changes to the metric will cause a change in routing, and not all changes in routing will produce a decrease in utilization on the candidate link. The routing protocols generally use the assigned metric to compare alternative routes for a given traffic flow between nodes. For example, if the candidate link provides the only path for a particular traffic flow, the routing of that path will always include this link, regardless of the value of the metric, because there is no alternative link for this segment of the path. In like manner, if the metric for this link is substantially different from any of the other links, small changes to the metric will not affect the routing based on a comparison of these metrics. When the metric is comparatively similar to another metric will a change to the metric have a potential effect on the choice of routes for the particular traffic flow.

In stage 316-1, the traffic engineering server 122 identifies the traffic demands of the candidate link and generates a list. The traffic engineering server 122 may obtain this information, for example, from the traffic engineering database 124 and network model 132.

In stage 316-2, the traffic engineering server 122 the selects the traffic demand having the highest delay violation.

In stage 316-3, the traffic engineering server 122 then computes a lower bound for the delay. For example, as noted above with reference to FIG. 2 above, the traffic engineering server 122 may employ a Djikstra's shortest path algorithm to compute this lower bound.

In stage 316-4, the traffic engineering server 122 may compute the shortest paths for the traffic demand through network 102. For example, the traffic engineering server 122 may determine this information from network model 132 and routes 138.

In stage 316-5, the traffic engineering server 122 checks if all paths of the traffic demand travel through the current candidate link. If so, in stage 316-6, then the traffic engineering server 122 concludes that the delay violation is not repairable by changing the metric on the current candidate link. The traffic engineering server 122 may then remove this traffic demand from the list.

In stage 316-7, the traffic engineering server 122 has determined that some parts of the traffic demand traverse through other links. Thus, the traffic engineering server 122 may repair the delay violation for this traffic by rerouting traffic to other links. The traffic engineering server 122 thus computes a metric difference between the delay compliant path and the original path. In addition, traffic engineering server 122 may remove this traffic demand from the list.

In stage 316-8, the traffic engineering server 122 checks if it has finished processing its list of traffic demands. If not, then loops back to stage 316-2 and processing repeats.

In stage 316-9, the traffic engineering server 122 has completed analyzing its list of traffic demands and then computes a metric change range that covers all the demands processed. FIG. 3D is provided below and illustrates how the traffic engineering server 122 computes a metric change range.

In stage 316-10, the traffic engineering server 122 then selects a new metric from the metric range that reduces the total delay violations by the current candidate link.

FIG. 3D—Exemplary Metric Change Range

Referring now the FIG. 3D, when a candidate link is chosen, the algorithm then calculates the new metric value for the interface. In order to determine this metric value, in some embodiments, a metric change range is computed. As shown in FIG. 3D, the metric change range is given by the minimum and maximum metrics between which the repairable delay violation of a flow traversing the candidate link can be reduced. Accordingly, the repairable delay violation is defined as the delay violation minus the propagation delay lower bound of this flow. The repairable delay violation is then used to eliminate the impact of infeasible (i.e. too tight) delay constraints.

In the example illustrated, the initial repairable delay violation is 22 ms, and by calculating the possible routes of the flow, the traffic engineering server 122 finds that the lowest metric to change to is 17, under which a higher violation of 27 ms will result (which is worse than the initial violation). And the highest metric is 29, above which a further increase of metric will not reduce the delay violation. Therefore, in the example shown, the determined metric change range is (17, 29).

FIG. 4A—Exemplary Flow-Based Algorithm

FIG. 4A illustrates a flow chart of the flow-based algorithm. As can be seen, the process shown in FIG. 4A employs many of the same stages as the process shown in FIG. 3A. Accordingly, for purposes of brevity, the stages that are the same are not described again. As can be seen, various stages may be performed in different order in some embodiments. In addition, new stages and differences of the algorithm shown in FIG. 4A relative to the algorithm shown in FIG. 3A will now be explained below.

In the embodiment shown in FIG. 4A, in stage 314, the traffic engineering server 122 first checks whether the utilization constraint is satisfied. If not, then the traffic engineering server 122 attempts to reduce the max link utilization as described above with reference to FIG. 3A.

However, in this alternative embodiment, if the utilization constraint has already been satisfied, the traffic engineering server 122 will attempt to repair delay violations in network 102. In particular, the traffic engineering server 122 will try to route the flows to lower delay paths without breaking the utilization constraint that is already satisfied.

In stage 402, the traffic engineering server 122 will identify candidate traffic demands to be worked on. For example, traffic demands may relate to data traffic between clients 112 and/or web server 104, application server 108, database server 108, etc.

To efficiently identify candidate interfaces traversed by a delay-violated flow, and compute the necessary metric changes, the traffic engineering server 122 determines information regarding the multiple possible routes of the flow. For example, in one embodiment, the traffic engineering server 122 computes the k-shortest path algorithm, such as using Djikstra's algorithm, to compute these possible routes, where the propagation delay of the links are used as the weights.

In stage 404, the traffic engineering server 122 will select a candidate demand (or flow) to fix this delay violation. In one embodiment, the traffic engineering server 122 may create a table storing the metric (m) and delay (d) associated with each route, and sort the table with descending delay and ascending metric order. An exemplary table (Table 1) is shown below.

TABLE 1
Metric/Delay Table

| Route Entry Number | Delay (ms) | Metric |
|---|---|---|
| 0001 | 40 | 9 |
| 0002 | 35 | 12 |
| 0003 | 30 | 5 |
| 0004 | 15 | 14 |
| 0005 | 15 | 16 |

Using this table, the traffic engineering server 122 can thus identify the first entry that satisfies the delay constraint of 25 milliseconds. In the example, this is entry #4, which has a route delay of 15 ms and a route metric of 14. Of note, this entry is chosen over entry #5 since it will require less change on lower metric routes to make the target route have the lowest metric.

Next, in stage 406, the traffic engineering server 122 will then identify the interface on each route that violates the delay constraint. On route entry #1, #2, and #3, find the interface with the max propagation delay.

In stage 408, the traffic engineering server 122 identifies the metric difference between each delay violating route and the target route, which will be 5, 2, 9, respectively. Next, the traffic engineering server 122 increments the metrics to attempt to reroute the demand to a lower delay route. For example, the traffic engineering server 122 may increment the interfaces identified with the value identified above plus 1. Adding 1 is included in this algorithm to make the target route have the lowest route metric among all the possible routes. The new route delay and metric table may then result in an exemplary table shown below. As can be seen in Table 2 below, the routing metrics for Route Entry Numbers 0001, 0002, and 0003 have been revised to a value of 15.

TABLE 2
Revised Metric/Delay Table

| Route Entry Number | Delay (ms) | Metric |
|---|---|---|
| 0001 | 40 | 15 |
| 0002 | 35 | 15 |
| 0003 | 30 | 15 |
| 0004 | 15 | 14 |
| 0005 | 15 | 16 |

Of note, some of the interfaces identified may have duplicates, i.e. some routes share a common interface. Accordingly, in some embodiments, the algorithm will only increment the metric for this common interface once, thus reducing the number of metric changes. After the metric changes are committed, the new metrics on the possible routes will be calculated. In some embodiments, processing then proceeds in similar fashion as shown in FIG. 3A.

FIGS. 4B-4C

FIG. 4B illustrates an example of five possible routes between a source and destination. As shown, the “Initial Route” has a delay violation, which the traffic engineering server 122 is attempting to repair. In the example shown, each route has a metric (m) and delay (d) associated with it, and the initial route is Route1, which has the lowest metric among all the routes. Assuming the delay constraint given by the user is 25 milliseconds.

For purposes of illustration, FIG. 4C is also provided to illustrate the new routes that have been calculated. In this example, the Route 4 (“New Route”) may be selected as the new route to be used by the flow since it has the lowest metric.

Other system configuration and optimization features will be evident to one of ordinary skill in the art in view of this disclosure, and are included within the scope of the following claims. The features and attributes of the specific embodiments disclosed above may be combined in different ways to form additional embodiments, all of which fall within the scope of the present disclosure. Although the present disclosure provides certain embodiments and applications, other embodiments that are apparent to those of ordinary skill in the art, including embodiments, which do not provide all of the features and advantages set forth herein, are also within the scope of this disclosure. Accordingly, the scope of the present disclosure is intended to be defined only by reference to the appended claims.

What is claimed is:

1. A method for tuning routing metrics to satisfy compliance of performance of a network, wherein performance of the network is constrained by at least one end-to-end delay constraint, said method comprising:
determining a first plurality of metrics that are used by a routing protocol to select first routes for communication of messages among nodes of a network, each metric being associated with a corresponding cost of one or more of a plurality of links of the network;
determining a network performance measure based on first routes; and
modifying one or more select metrics of the first plurality of metrics to provide a second plurality of metrics that provides an improvement of the network performance measure based on second routes selected by the routing protocol based on the second plurality of metrics, wherein the modifying of the one or more select metrics is substantially limited to modifications that cause the routing protocol to comply with the end-to-end delay constraint.

2. The method of claim 1, wherein the network performance measure includes a measure of link utilization.

3. The method of claim 2, wherein the improvement includes a reduction in a maximum of link utilization among the plurality of links.

4. The method of claim 1, wherein modifying the one or more select metrics includes: selecting a candidate link having a link utilization that exceeds a link utilization threshold, determining a new value of the select metric corresponding to the candidate link to achieve a new route with a lower end-to-end delay, and setting the select metric to the new value.

5. The method of claim 4, including: identifying each of a set of metric values that provide a reduction of the link utilization for the candidate link, and determining the new value includes selecting from the set of metric values.

6. The method of claim 5, wherein each of the set of metric values corresponds to one of: a first metric value that causes the routing protocol to share a demand for the link with another link, and a second metric value that causes the routing protocol to select another link for routing the demand with a lower delay.

7. The method of claim 1, wherein the one or more select metrics correspond to one or more links that are randomly selected from a set of candidate links.

8. The method of claim 1, wherein the set of candidate links correspond to links having a high degree of utilization and satisfying a respective delay constraint.

9. The method of claim 8, wherein the links are randomly selected based on a probability of selection that is based on a degree of utilization and latency of each link.

10. The method of claim 1, wherein the one or more select metrics are selected based on a cost associated with reducing delay of the route by modifying the metric.

11. A system for tuning route metrics to satisfy one or more delay constraints desired for a network comprising:
a configuration engine coupled to a network and configured to determine a first plurality of metrics that are used by a routing protocol to select first routes for communication of messages among nodes of a network, each metric being associated with a corresponding cost of one or more of a plurality of links of the network; and
a traffic engineering server configured to determine a network performance measure based on first routes and modify one or more select metrics of the first plurality of metrics to provide a second plurality of metrics that provides an improvement of the network performance measure based on second routes selected by the routing protocol based on the second plurality of metrics, wherein the modifications of the one or more select metrics is substantially limited to modifications that cause the routing protocol to comply with the end-to-end delay constraint.

12. The system of claim 11, wherein the configuration engine is configured to measure link utilization.

13. The system of claim 11, wherein the traffic engineering server is configured to select a candidate link having a link utilization that exceeds a link utilization threshold, determine a new value of the select metric corresponding to the candidate link to achieve a new route with a lower end-to-end delay, and set the select metric to the new value.

14. The system of claim 13, wherein the traffic engineering server is configured to identify each of a set of metric values that provide a reduction of the link utilization for the candidate link, and determine the new value based on a set of metric values.

15. The system of claim 14, wherein each of the set of metric values corresponds to one of: a first metric value that causes the routing protocol to share a demand for the link with another link, and a second metric value that causes the routing protocol to select another link for routing the demand with a lower delay.

16. The system of claim 11, wherein the traffic engineering server is configured to randomly select one link from a set of candidate links.

17. The system of claim 11, wherein the traffic engineering server is configured to select candidate links based on a degree of utilization and latency of each link.

18. The system of claim 11, wherein the traffic engineering server is configured to select links having a high degree of utilization and satisfying a respective delay constraint for candidate links.

19. The system of claim 11, wherein the traffic engineering server is configured to select one or more metrics based on a cost associated with reducing delay of the route by modifying the metric.
